(19) United States
(12) Patent Application Publication
(10) Pub. No.: US 2016/0148168 A1
(43) Pub. Date: May 26, 2016

(54) SYSTEM AND METHOD FOR TASK DISTRIBUTION IN CROWDSOURCING

(71) Applicant: XEROX CORPORATION, Norwalk, CT (US)

(72) Inventors: Mohit Sorde, Maharashtra (IN); Preethi Raj Raajaratnam, Chennai (IN); Chithralekha Balamurugan, Pondicherry (IN)

(21) Appl. No.: 14/554,097

(22) Filed: Nov. 26, 2014

(51) Int. Cl. G06Q 10/10; H04L 12/24; H04L 29/08; G06Q 10/06; G06Q 30/02; G06Q 50/00; H04W 4/00

(52) U.S. Cl. CPC G06Q 10/1097; G06Q 50/01; H04L 41/0654; H04W 4/008; G06Q 10/063112; G06Q 30/02; H04L 67/02

(57) ABSTRACT

The disclosed embodiments illustrate methods and systems for distributing crowdsourcing tasks. The method includes receiving a handshake request, by a host device from a client device, at least for accessing one or more first crowdsourcing tasks, such that the client device has sporadic internet connectivity. Thereafter, in response to the handshake request a message is transmitted by the host device to the client device. The message includes at least an information pertaining to one or more second crowdsourcing tasks received from a crowdsourcing platform server. Further, the one or more first crowdsourcing tasks are transmitted by the host device to the client device. This transmission is based at least on a validation of one or more second responses, received from the client device, associated with the one or more second crowdsourcing tasks.

### TECHNICAL FIELD

The presently disclosed embodiments are related, in general, to crowdsourcing. More particularly, the presently disclosed embodiments are related to methods and systems for distributing crowdsourcing tasks to a client device with sporadic internet connectivity.

### BACKGROUND

Crowdsourcing platforms provide an online job market where workers connect to a crowdsourcing platform server and execute tasks posted by requesters. There exists an exponential growth in the number of workers available for task execution on the crowdsourcing platforms. However, the workers have to be always connected to the crowdsourcing platform over the Internet to perform tasks. Thus, workers based out of places, especially rural parts of a country, where internet connection is expensive and is intermittent, are excluded from working on crowdsourced tasks for monetary benefits. Although mobile phones are persistent in these places, the mobile phones may not be utilized effectively for executing tasks because of the limited Internet connectivity and requirement to pay according to Internet usage time.

In addition, connection of the workers to the Internet for prolonged time to work on tasks may result in several limitations for the workers in actively contributing in the crowdsourced tasks. One of such limitations may be that the workers lose a fraction of their earnings to pay for good Internet connectivity to stay connected during the entire period of task selection, execution, and completion. Another limitation corresponds to the worker productivity that is dependent on factors, such as network latency, waiting time between submitting a task and loading the next task on a browser. These factors, collectively, may lower the worker productivity, affecting a worker's earning potential.

Apart from the constant internet connection restriction, the role of a worker is limited merely to a consumer of tasks instead of a distributor of tasks, such that the workers attempt the tasks posted by the requesters and distributed by the crowdsourcing platform server.

### SUMMARY

According to embodiments illustrated herein, there is provided a method for distributing crowdsourcing tasks to a client device with sporadic internet connectivity. The method includes receiving, by a host device, a handshake request, from said client device at least for accessing one or more first crowdsourcing tasks. The method further includes transmitting, by said host device, a message to said client device in response to said handshake request. Said message includes at least an information pertaining to one or more second crowdsourcing tasks received from a crowdsourcing platform server. The method further includes transmitting, by said host device, said one or more first crowdsourcing tasks to said client device based at least on a validation of one or more second responses, received from said client device, associated with said one or more second crowdsourcing tasks.

According to embodiments illustrated herein, there is provided a method for accessing crowdsourcing tasks on a client device with sporadic internet connectivity. The method comprises transmitting, by said client device, a handshake request to a host device at least for accessing one or more first crowdsourcing tasks available on a crowdsourcing platform server. The method further includes receiving, by said client device, a message from said host device in response to said handshake request. Said message comprises at least an information pertaining to one or more second crowdsourcing tasks and an information pertaining to a gold task. The method includes transmitting, by said client device, one or more second responses, associated with said one or more second crowdsourcing tasks, and a response, associated with said gold task, to said host device. Said response, associated with said gold task, is utilized for validating said one or more second responses. The method further includes receiving, by said client device, said one or more first crowdsourcing tasks from said host device based at least on said validation of said one or more second responses.

According to embodiments illustrated herein, there is provided a method for distributing crowdsourcing tasks. The method includes receiving, by a crowdsourcing platform server, a first request, from a host device, for accessing one or more first crowdsourcing tasks. Said first request corresponds to a handshake request received, by said host device, from a client device for accessing said one or more first crowdsourcing tasks. The method further includes receiving, by said crowdsourcing platform server, a second request, from said host device, for accessing one or more second crowdsourcing tasks. Said one or more second responses, associated with said one or more second crowdsourcing tasks and provided by said client device, are indicative of said access of said one or more first crowdsourcing tasks, by said client device. The method includes transmitting, by said crowdsourcing platform server, said one or more first crowdsourcing tasks to said host device, based at least on a validation, by said host device, of said one or more second responses.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented;

FIG. 2 illustrates a message flow diagram for accessing/distributing crowdsourcing tasks, in accordance with at least one embodiment;

FIG. 3 is a block diagram illustrating a computing device for accessing/distributing crowdsourcing tasks, in accordance with at least one embodiment;

FIG. 4A and FIG. 4B illustrate a flowchart for distributing crowdsourcing tasks, in accordance with at least one embodiment; and

FIG. 5 is a flowchart illustrating a method for accessing crowdsourcing tasks, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk, Crowd Flower, or Mobile Works.

A “crowdworker” refers to a workforce/worker(s) that may perform one or more tasks that generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be used interchangeably. The crowdworker may perform the crowdsourcing tasks using various types of devices, such as, but not limited to, a laptop, a mobile phone, a PDA, a tablet, a phablet, and the like.

A “crowdsourcing task” refers to a piece of work, an activity, an action, a job, an instruction, or an assignment to be performed. Tasks may necessitate the involvement of one or more workers. Examples of tasks may include, but are not limited to, image/video/text labelling/tagging/categorisation, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g., of product placement), text/image-analysis, directory compilation, or information search/retrieval.

A “host device” refers to a computing device that may access one or more crowdsourcing tasks on crowdsourcing platform server over the internet. The host device may include different types of devices, such as, but not limited to, desktop computers, laptops, netbooks, PDAs, smartphones, tablets, and so on. In an embodiment, the host device may access the crowdsourcing platform server through other host device. Further, the connections made in the entire process of the communication with the crowdsourcing platform server can be either wired or wireless. In an embodiment, the host device may correspond to hotspot devices that have built in routers to route the messages/data to/from the crowdsourcing platform server.

A “client device” refers to a computing device that may be utilized by a crowdworker, for selecting and executing one or more crowdsourcing tasks posted by one or more requestors on the crowdsourcing platform server. The client device may include, but is not limited to a smartphone, a laptop, a personal digital assistant (PDA), a tablet, a desktop computer, and the like. In an embodiment, the client device has limited/sporadic internet connectivity available with it and accesses the one or more crowdsourcing tasks through the internet connection available on a host device. In such a scenario, the client device may communicate with the host device on device-to-device communication protocols (e.g., Bluetooth, infrared, and Wi-Fi). Based on a mutual agreement between the client device and the host device, the charges corresponding to per unit access of data, by the client device, over the Internet connection, provided by the host device, may be determined.

A “handshake request” refers to a message transmitted by a client device to a host device. The client device may transmit the handshake request for at least one of accessing one or more first crowdsourcing tasks available on the crowdsourcing platform server or submitting one or more first responses for the previously attempted crowdsourcing tasks. In an embodiment, in response to the handshake request, the host device may transmit a message to the client device. The message from the host device may include at least an information pertaining to one or more second crowdsourcing tasks and a gold task. Based on the responses provided by the client device for the one or more second crowdsourcing tasks and the gold task, the host device may allow the client device for uploading/downloading information through it. Further, the message from the host device may include an information pertaining to the sharing of rewards, between the client device and the host device, for completing one or more crowdsourcing tasks.

“One or more first crowdsourcing tasks” refer to tasks that are posted by one or more requestors on the crowdsourcing platform server such that client devices may execute these tasks. Based on a validation mechanism, the client device may be allowed to upload/download information corresponding to the one or more first crowdsourcing tasks to the crowdsourcing platform server. In one embodiment, the host device may facilitate, using internet connection available on it, the client device to download the one or more first crowdsourcing tasks from the crowdsourcing platform server for execution. In addition, the host device may facilitate uploading of one or more first responses associated with the one or more first crowdsourcing tasks to the crowdsourcing platform server.

“One or more second crowdsourcing tasks” refer to tasks that are utilized to determine the access of crowdsourcing platform server by the client device. In an embodiment, the host device may download one or more second crowdsourcing tasks (e.g., through internet connection available on the host device) from the crowdsourcing platform server and transmit these tasks to the client device (e.g., through the device-to-device communication protocols). The client device may execute the one or more second crowdsourcing tasks and transmit the associated one or more second responses to the host device for submission to the crowdsourcing platform server. Based on the one or more second responses, the host device may facilitate the client device for accessing the crowdsourcing platform server. In one embodiment, the one or more second crowdsourcing tasks correspond to a predetermined category, such that the tasks in this category may be completed by least skillful crowdworkers associated with the crowdsourcing platform server.

A “gold task” refers to a crowdsourcing task that may be utilized by the host device for validating one or more second responses associated with the one or more second crowdsourcing tasks, provided by the client device. The host device may transmit the one or more second crowdsourcing tasks and the gold task to the client device. Based on a response, associated with the gold task and provided by the client device, the host device may validate the one or more second responses. In an embodiment, the host device may maintain a pool of crowdsourcing tasks that may be utilized as gold tasks. Further, the host device may receive the pool of the crowdsourcing tasks from the crowdsourcing platform server.

A “reward” refers to a remuneration paid to the crowdworker for completing a task posted on the crowdsourcing platform server. In an embodiment, examples of the reward may include, but are not limited to, a monetary compensation, lottery tickets, gift items, shopping vouchers, and discount coupons. In another embodiment, the reward may further correspond to strengthening of the relationship between the worker and the requestor. For example, the requestor may provide the worker with an access to more tasks so that the worker can gain more. In addition, through rewards, the crowdsourcing platform may improve a reputation score associated with the worker. In an embodiment, the worker with a higher reputation score may receive a higher reward. A person skilled in the art would understand that combination of any of the above-mentioned means of reward could be used and the task completion cost for the requestors may be inclusive of such rewards receivable by the corresponding workers.

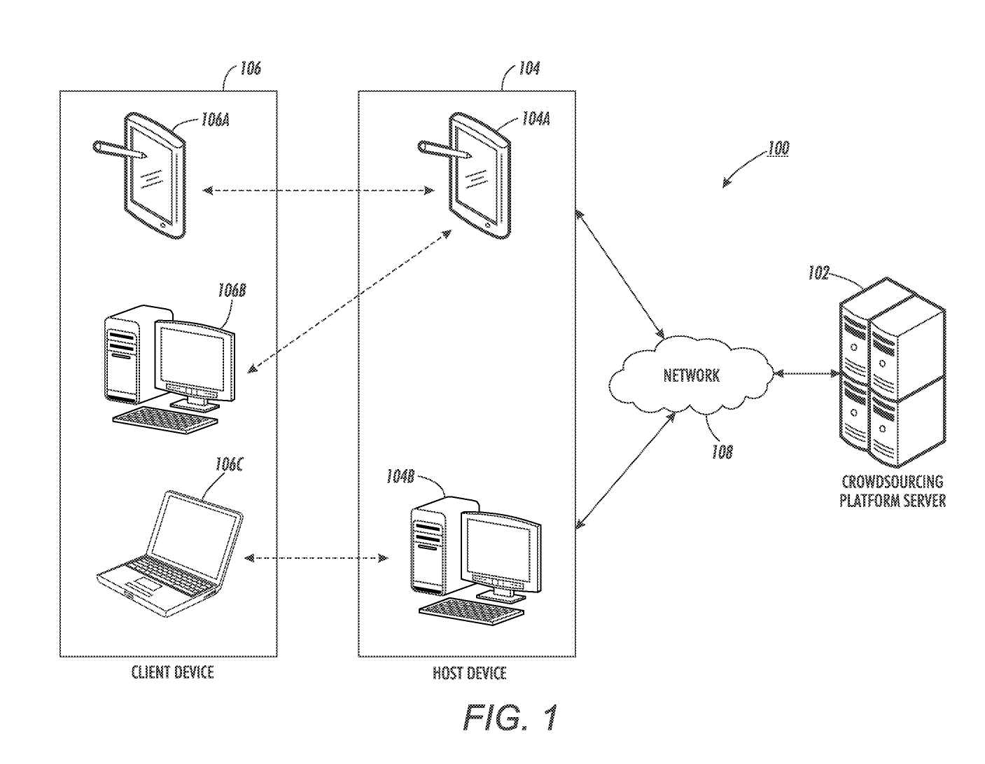

FIG. 1 is a block diagram of a system environment 100, in which various embodiments can be implemented. The system environment 100 includes a crowdsourcing platform server 102, one or more host devices 104a and 104b (also referred to as host device 104), one or more client devices 106a, 106b, and 106c (also referred to as client device 106), and a network 108.

The crowdsourcing platform server 102 refers to a computing device that is configured to host one or more crowdsourcing platforms. In an embodiment, the crowdsourcing platform server 102 may receive one or more tasks from one or more requestors. In an embodiment, the crowdsourcing platform server 102 may transmit these crowdsourcing tasks to the host device 104. Further, the crowdsourcing platform server 102 may interact with the host device 104 over the network 108. In an embodiment, the crowdsourcing platform server 102 may forward one or more first responses associated with one or more first crowdsourcing tasks from the one or more crowdworkers to the one or more requestors. Further, the crowdsourcing platform server 102 may transmit rewards to the host device 104 on the completion of the one or more crowdsourcing tasks. In an embodiment, the crowdsourcing platform server 102 may provide the rewards in the monetary form (e.g., cash, discount coupons, gift vouchers, and lottery tickets). In an alternate embodiment, the crowdsourcing platform server 102 may provide the rewards in non-monetary form. For example, the crowdsourcing platform server 102 may provide access of more crowdsourcing tasks on completing a minimum number of crowdsourcing tasks. The crowdsourcing platform server 102 may be realized through an application server such as, but not limited to, a Java application server, a .NET framework, and a Base4 application server.

The host device 104 refers to a computing device that interacts with the crowdsourcing platform server 102 for accessing one or more crowdsourcing tasks. In an embodiment, the host device 104 receives a handshake request, from the client device 106, for accessing the one or more first crowdsourcing tasks. In an alternate embodiment, the handshake request may correspond to submission of responses, for previously attempted tasks by the client device 106. In response to the handshake request, the host device 104 may transmit a message to the client device 106 that includes an information pertaining to one or more second crowdsourcing tasks and a gold task to the client device 106. The message from the host device 104 may also include an information pertaining to the sharing of the rewards, between the client device 106 and the host device 104, received from the crowdsourcing platform server 102. Further, the host device 104 may receive one or more second responses, associated with the one or more second crowdsourcing tasks, and a response associated with the gold task, from the client device 106. Based on a validation of the one or more second responses, the host device 104 may allow the client device 106 for accessing the one or more first crowdsourcing tasks from the crowdsourcing platform server 102. The communication between the host device 104 and the crowdsourcing platform server 102 is over the internet, and the communication between the host device 104 and the client device 106 is over the device-to-device communication protocols. Thus, in this way, the host device 104 mediates between the client device 106 and the crowdsourcing platform server 102. Examples of the host device 104 include, but are not limited to, a smartphone, a laptop, a personal digital assistant (PDA), a tablet, a desktop computer, and the like. In an embodiment, the host device 104 may correspond to a hotspot device that includes a built-in router for exchanging data/messages to/from the crowdsourcing platform server 102.

The client device 106 refers to a computing device, utilized by a crowdworker, for selecting and executing the one or more first crowdsourcing tasks posted by one or more requestors on the crowdsourcing platform server 102. In an embodiment, the client device 106 has limited/sporadic internet connectivity, and thus to initiate the communication with the crowdsourcing platform server 102, the client device 106 identifies the host device 104, through a device-to-device communication protocol, such as, but not limited to, Bluetooth, near field communication (NFC), Infrared, Universal Serial Bus (USB) tethering, Wi-Fi tethering, and so on. Subsequently, the client device 106 may transmit the handshake request to the host device 104 through such communication protocols. In one embodiment, in response to the handshake request, the client device 106 receives the one or more second crowdsourcing tasks along with the gold task from the host device 104. The response associated with the gold task is utilized to validate the one or more second responses associated with the one or more second crowdsourcing tasks, based on which the client device 106 is granted access to the one or more first crowdsourcing tasks available on the crowdsourcing platform server 102. Thereafter, the client device 106 may submit the one or more first responses associated with the one or more first crowdsourcing tasks, through the host device 104, to the crowdsourcing platform server 102. In an embodiment, the client device 106 may transmit the handshake request for submitting the responses for previously attempted crowdsourcing tasks (e.g. attempted through other host devices) Examples of the client device 106 may include, but are not limited to, a smartphone, a laptop, a personal digital assistant (PDA), a tablet, a desktop computer, and the like.

The network 108 corresponds to a medium through which content and messages flow between various devices of the system environment 100 (e.g., the crowdsourcing platform server 102 and the host device 104). Examples of the network 108 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

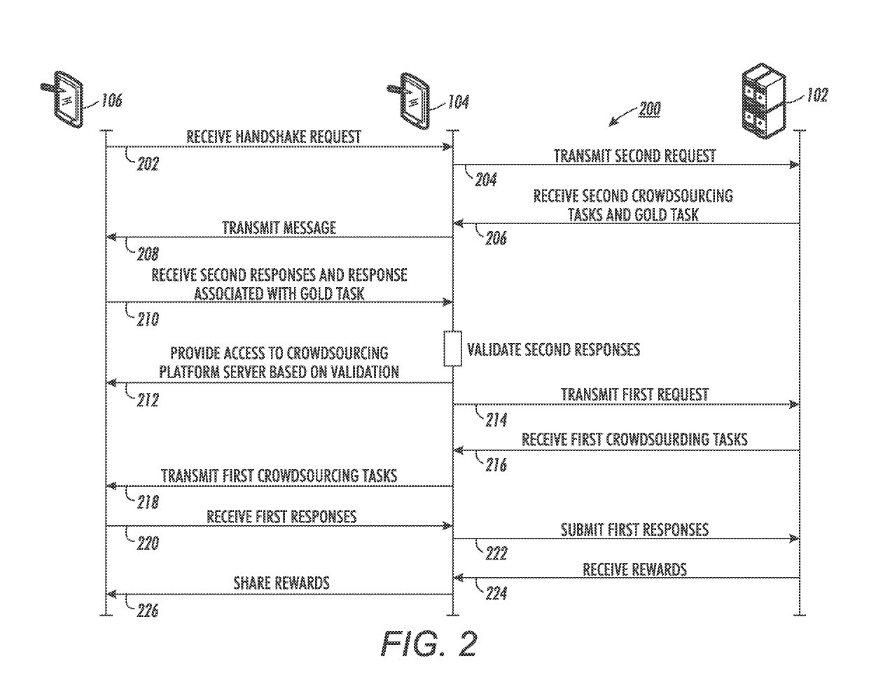

FIG. 2 illustrates a message flow diagram 200 illustrating flow of the messages/data between different components of the system environment 100, in accordance with at least one embodiment. The message flow diagram 200 has been described in conjunction with FIG. 1.

The handshake request, transmitted by the client device 106, is received by the host device 104 (depicted by message 202). The handshake request may correspond to the request for accessing the one or more first crowdsourcing tasks available on the crowdsourcing platform server 102. In an embodiment, the handshake request may correspond to the request for submitting the one or more first responses associated with one or more previously attempted first crowdsourcing tasks.

In response to the handshake request, the host device 104 transmits a second request to the crowdsourcing platform server 102 (depicted by message 204). The second request corresponds to the request for accessing the one or more second crowdsourcing tasks available on the crowdsourcing platform server 102.

The host device 104 receives the one or more second crowdsourcing tasks and the gold task from the crowdsourcing platform server 102, in response to the second request (depicted by message 206).

The host device 104 transmits the message including the information pertaining to the one or more second crowdsourcing tasks and the gold task, to the client device 106 (depicted by message 208). In an embodiment, through the message, the client device 106 receives the one or more second crowdsourcing tasks and the gold task for execution.

The host device 104 receives the one or more second responses associated with the one or more second crowdsourcing tasks and the response associated with the gold task (depicted by message 210). In an embodiment, the response associated with the gold task is utilized for validating the one or more second responses.

Based on the validation, the host device 104 provides the client device 106, the access to the crowdsourcing platform server 102 (depicted by message 212). In an embodiment, the host device 104 may provide access for uploading/downloading information to/from the crowdsourcing platform server 102. In an embodiment, downloading of the information may correspond to accessing the one or more first crowdsourcing tasks, and the uploading of the information may correspond to submitting the one or more first responses associated with the previously attempted one or more first crowdsourcing tasks.

The host device 104 transmits a first request to the crowdsourcing platform server 102 (depicted by message 214). The first request may correspond to access for the one or more first crowdsourcing tasks available on the crowdsourcing platform server 102.

The host device 104 receives the one or more first crowdsourcing tasks from the crowdsourcing platform server 102 (depicted by message 216).

The host device 104 transmits the one or more first crowdsourcing tasks to the client device 106 for execution (depicted by message 218).

The host device 104 receives the one or more first responses associated with the one or more first crowdsourcing tasks from the client device 106 (depicted by message 220). In an embodiment, the client device 106 executes the received one or more first crowdsourcing tasks and then transmits the associated one or more first responses to the host device 104.

The host device 104 submits the one or more first responses associated with the one or more first crowdsourcing tasks to the crowdsourcing platform server 102 (depicted by message 222).

Based on the accuracy of the submitted one or more first responses, the host device 104 receives the rewards from the crowdsourcing platform server 102 (depicted by message 224).

The host device 104 shares the rewards provided by the crowdsourcing platform server 102, with the client device 106 (depicted by message 226).

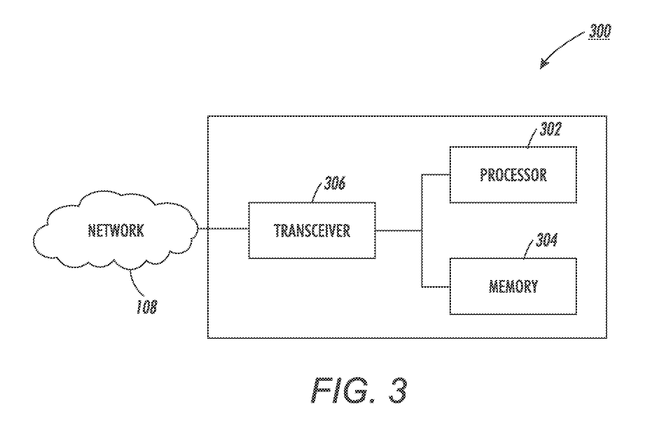

FIG. 3 is a block diagram that illustrates a computing device 300 for accessing/distributing one or more crowdsourcing tasks, in accordance with at least one embodiment. In an embodiment, the computing device 300 may correspond to at least one of the host device 104 or the client device 106.

The computing device 300 includes a processor 302, a memory 304, and a transceiver 306. The processor 302 is coupled to the memory 304 and the transceiver 306. The transceiver 306 is connected to the network 108.

The processor 302 includes suitable logic, circuitry, and/or interfaces that are operable to execute one or more instructions stored in the memory 304 to perform predetermined operations. The processor 302 may be implemented using one or more processor technologies known in the art. Examples of the processor 302 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor.

The memory 304 stores a set of instructions and data. Some of the commonly known memory implementations include, but are not limited to, a random access memory (RAM), a read only memory (ROM), a hard disk drive (HDD), and a secure digital (SD) card. Further, the memory 304 includes the one or more instructions that are executable by the processor 302 to perform specific operations. It is apparent to a person with ordinary skills in the art that the one or more instructions stored in the memory 304 enable the hardware of the computing device 300 to perform the predetermined operations.

The transceiver 306 transmits and receives messages and data to/from various components of the system environment 100 (e.g., the crowdsourcing platform server 102 and the host device 104) over the network 108. Examples of the transceiver 306 may include, but are not limited to, an antenna, an Ethernet port, a USB port, or any other port that can be configured to receive and transmit data. The transceiver 306 transmits and receives data/messages in accordance with the various communication protocols, such as, TCP/IP, UDP, and 2G, 3G, or 4G communication protocols.

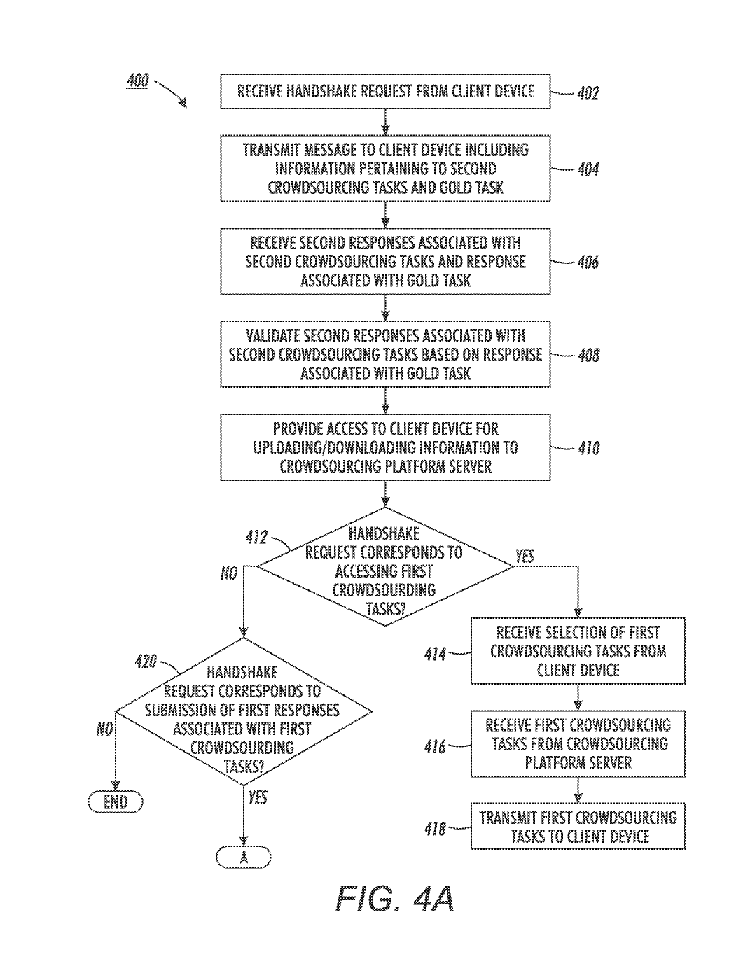

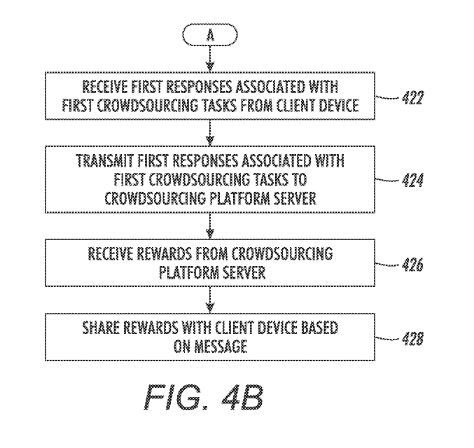

FIG. 4A and FIG. 4B illustrate a flowchart 400 for distributing crowdsourcing tasks, in accordance with at least one embodiment. The flowchart 400 is described in conjunction with FIG. 1, FIG. 2, and FIG. 3. For the purpose of ongoing description of the flowchart 400, the computing device 300, shown in FIG. 3, corresponds to the host device 104.

At step 402, the processor 302 receives the handshake request from the client device 106 being operated by the crowdworker, who may choose to communicate with the crowdsourcing platform server 102. The processor 302 receives the handshake request through at least one of a Bluetooth protocol, a near field communication (NFC) protocol, an Infrared protocol, a Universal Serial Bus (USB) tethering, or a Wi-Fi tethering. In an embodiment, the processor 302 may receive the handshake request from more than one client device. In an embodiment, the crowdworker who is operating the client device 106 may want to access the one or more first crowdsourcing tasks that are available on the crowdsourcing platform server 102. In such a scenario, the client device 106 may search for the host device 104 through one or more protocols and transmit the handshake request for accessing the one or more first crowdsourcing tasks. In an embodiment, the client device 106 may transmit the handshake request for submitting the one or more first responses associated with the one or more first crowdsourcing tasks. In such a scenario, the client device 106 may have previously attempted the one or more first crowdsourcing tasks through other host devices, and may subsequently transmit the handshake request for submitting the one or more first responses.

At step 404, the processor 302, in response to the handshake request, transmits the message to the client device 106. The message includes the information pertaining to the one or more second crowdsourcing tasks. The one or more second crowdsourcing tasks may refer to the crowdsourcing tasks from a predetermined category that the client device 106 may be required to execute to initiate the communication with the crowdsourcing platform server 102 (through the host device 104). Thus, in an embodiment, the processor 302 utilizes the one or more second crowdsourcing tasks for authentication/authorization of the client device 106. In an embodiment, the predetermined category is determined such that it includes the crowdsourcing tasks that may be completed by least skillful crowdworkers associated with the crowdsourcing platform server 102. In an embodiment, the crowdsourcing platform server 102 may maintain the list of skills required to perform the one or more second crowdsourcing tasks, and subsequently may transmit the one or more second crowdsourcing tasks to the processor 302. The processor 302 may further forward the one or more second crowdsourcing tasks to the client device 106, in response to the handshake request.

In an embodiment, prior to transmitting the one or more second crowdsourcing tasks, the processor 302 may determine a count of such tasks. The processor 302 may determine the count based on the type of the handshake request. For example, as discussed, the handshake request may correspond to the access of the one or more first crowdsourcing tasks, or may correspond to the submission of the one or more first responses associated with the one or more first crowdsourcing tasks. Based on the handshake request from the client device 106, the processor 302 may determine amount of internet data that would be required to satisfy the handshake request. Subsequently, based on the rewards paid by the crowdsourcing platform server 102 for the one or more second crowdsourcing tasks and the internet data charges that the host device 104 pays to the internet service provider, the processor 302 may determine the count of the one or more second crowdsourcing tasks. For example, if the client device 106 transmits the handshake request, such that the handshake request requires 10 MB of data usage. In such a scenario, if the host device 104 pays 1 cent per KB to the internet service provider, then the processor 302 may determine the count of the one or more second crowdsourcing tasks that can recover this much amount of charges (i.e., 1 cent*2048 KB=2048 cents). That is, the host device 104 may determine the count of the one or more second crowdsourcing tasks as 10 if each of those 10 second crowdsourcing tasks has 204.8 cents of rewards associated with it. In an embodiment, the host device 104 may keep the rewards earned through the one or more second crowdsourcing tasks with it and in lieu of that provide the client device 106 the access to the crowdsourcing platform server 102, in accordance with the handshake request.

In an embodiment, the processor 302 may determine the amount of data usage, which should be granted to the client device 106, based on the count of the one or more second crowdsourcing tasks. For example, if the handshake request from the client device 106 is such that it requires 10 MB of data usage and the processor 302 has pre-configured 10 second crowdsourcing tasks (each with a reward of 10 cents) to be transmitted to any client device 106 for validating each handshake request, the processor 302 may determine the amount of data bandwidth that may be shared with the client device 106 based on the rewards earned through these 10 crowdsourcing tasks. That is, since the rewards earned through these 10 crowdsourcing tasks are 100 cents (10 cents for 10 tasks) and if data charges paid by the host device 104 to the internet service provider are 1 cent/KB then the data bandwidth would be 100 KB (for earning 100 cents at the rate of 1 cent/KB).

In an embodiment, along with the one or more second crowdsourcing tasks, the processor 302 may transmit the gold task to the client device 106. In an embodiment, the response associated the gold task, provided by the client device 106, may be used to validate the one or more second responses associated with the one or more second crowdsourcing tasks. For example, the processor 302 may know the correct response associated with the gold task, and if the response, provided by the client device 106, is found to be correct, the processor 302 considers other responses, associated with the one or more second crowdsourcing tasks, as correct. Thus, in this way, the host device 104 may perform the function (i.e., the validation) that is typically performed by the requesters.

In an embodiment, the processor 302 may maintain a pool of gold tasks in the memory 304. Further, the processor 302 may track the client device 106 and a set of gold tasks, from the pool of gold tasks, which have been transmitted to the client device 106, such that the client device 106 is not transmitted the same task, as gold task, for two times. At every instance, on receiving the handshake request by the client device 106, the processor 302 determines a gold task (from the pool of gold tasks) to be transmitted to the client device 106 for providing access for uploading/downloading of information to the crowdsourcing platform server 102.

In an embodiment, the processor 302 receives the one or more second crowdsourcing tasks and the pool of gold tasks from the crowdsourcing platform server 102. Further, the processor 302 may utilize the internet connection available on the host device 104 to initiate a communication session (e.g., over Hypertext Transfer Protocol (HTTP)) with the crowdsourcing platform server 102. Further, the processor 302 may maintain a check on the pool of the gold tasks, and if all the tasks available in the pool of gold tasks have been transmitted to the client device 106, the processor 302 may receive more tasks, from the crowdsourcing platform server 102, which may be utilized as the gold tasks.

In an embodiment, prior to transmitting the one or more second crowdsourcing tasks to the client device 106, the processor 302 may authenticate the client device 106 for a resource availability to execute the one or more second crowdsourcing tasks. In an embodiment, the processor 302 may check the client device 106 for security threats. In case, the client device 106 meets the required resource requirements and does not have any security threats, the processor 302 may transmit the one or more second crowdsourcing tasks to the client device 106 for execution.

In an embodiment, the processor 302, in the message, may include the information pertaining to a sharing of the rewards, associated with the one or more first crowdsourcing tasks, between the host device 104 and the client device 106. For example the message, transmitted by the processor 302, in response to the handshake request, may specify the percentage of the rewards associated with the first crowdsourcing tasks (received from the crowdsourcing platform server 102) that the host device 104 will keep for itself. In an embodiment, prior to transmitting the one or more second crowdsourcing tasks and the gold task, the processor 302 may transmit such information (i.e. pertaining to the sharing of the rewards), and based on the acceptance by the client device 106, the processor 302 may subsequently transmit the one or more second crowdsourcing tasks and the gold task, as discussed above.

In one embodiment, the processor 302 determines active time to execute the selected one or more second crowdsourcing tasks. In an embodiment, the processor 302 determines, the active time based on task-completion time (e.g., specified by the requester on the crowdsourcing platform server 102) associated with the respective crowdsourcing tasks and a random time. In an embodiment, to determine the active time, the processor 302 may utilize below provided equation:

Active Time=Task completion time+Random time (1)

where,

random time is a pre-configurable time interval.

In an embodiment, the pre-configurable time interval is selected such that determined active time is less than the expiry time of the respective task on the crowdsourcing platform server 102. In an example, the client device 106 opts for ‘10’ tasks from ‘Digitization’ and ‘15’ tasks from ‘Image Labelling’. Further, each of ‘Digitization’ and ‘Image Labelling’ tasks take ‘2’ min for execution.

Digitization tasks=10

Image Labelling tasks=15

Digitization tasks execution time=2 min

Image Labelling tasks execution time=2 min

Task Completion Time=(2*(10+25))=50 min

Random Time=10 min (20% of total execution time)

Active Time=50+10=60 min

It should be apparent to a person skilled in the art that the active time may be chosen such that it is less than an expiry time associated with the selected one or more first crowdsourcing tasks.

In one embodiment, the processor 302 may determine active time to execute the one or more first crowdsourcing tasks.

At step 406, the one or more second responses associated with the one or more second crowdsourcing tasks and the response associated with the gold task are received by the processor 302. In an embodiment, the processor 302 may receive the one or more second responses and the response associated with the gold task, from the client device 106. As discussed, the processor 302 may receive these responses over the communication protocols, such as Bluetooth, NFC, infrared, USB tethering, Wi-Fi tethering, and the like. In this way, in a scenario when the client device 106 does not have the internet connectivity available with it, the client device 106 may still execute a task and provide a response to the host device 104.

At step 408, the processor 302 validates the one or more second responses associated with the one or more second crowdsourcing tasks. As discussed above, the processor 302 may validate the one or more second responses based on the response associated with the gold task. That is, if the response associated with the gold task, provided by the client device 106, is correct, then the processor 302 may consider the one or more second responses associated with the one or more second crowdsourcing tasks as correct.

At step 410, the processor 302 provides access to the client device 106 for uploading/downloading information to/from the crowdsourcing platform server 102. In an embodiment, the processor 302 may determine whether the client device 106 may be allowed access to the crowdsourcing platform server 102, based on the one or more second responses associated with the one or more second crowdsourcing tasks, received from the client device 106. That is, if the processor 302 determines that the one or more second responses are correct, the processor 302 may allow the client device 106 to access the crowdsourcing platform server 102 through it. In an embodiment, downloading of the information may correspond to accessing the one or more first crowdsourcing tasks, and the uploading of the information may correspond to submitting the one or more first responses associated with the previously attempted one or more first crowdsourcing tasks. In an embodiment, the processor 302 may define a percentage of correct responses, from the one or more received second responses, for determining access to the client device 106. For example, the processor 302 may determine that if the percentage of the correct second responses received from the client device 106 is at least 75%, the client device 106 may be allowed access of the crowdsourcing platform server 102.

In an embodiment, the client device 106 may be notified about the provision of the access of the crowdsourcing platform server 102. For example, the processor 302 may notify the client device 106, through a pop-up/flash message on a display associated with the client device 106, about the provision of access.

At step 412, it is determined whether the handshake request corresponds to the access of the one or more first crowdsourcing tasks. If the processor 302 determines that the handshake request corresponds to the access of the one or more first crowdsourcing tasks, step 414 is performed else step 420 is performed.

At the step 414, the processor 302 receives a selection of the one or more first crowdsourcing tasks from the client device 106. In an embodiment, the processor 302 may offer multiple options to minimize the time spent by the client device 106 on task selection. For example, the processor 302 may offer a selection by category (‘n’ tasks of form digitization type) or selection by requester (‘n’ tasks from Xerox). Alternatively, the processor 302 may offer the client device 106 ‘n’ tasks that have been most recently attempted by the client device 106. In an embodiment, the processor 302 may offer tasks with the highest rewards and so on. In another embodiment, the processor 302 may set a choice as recurrent, where the same query may be periodically repeated to fetch an updated list of tasks from the crowdsourcing platform server 102 that may further be transmitted to the client device 106. Additionally, the processor 302, based on the previous task selection by the client device 106 may auto-suggest tasks for the client device 106 and, thus, optimizing time involved for task selection. Through, such different means, the processor 302 may facilitate the client device 106 for the selection of the one or more first crowdsourcing tasks.

Typically, the processor 302 may have multiple alternatives for task selection through the client device 106. At various instances, the client device 106 may have the primary set of tasks having priority, which are not available on the crowdsourcing platform server 102. In such scenarios, the processor 302 may facilitate the client device 106 for the searching of the list of secondary options predefined by the client device 106. Further, the client device 106 may choose a total number of ‘n’ tasks for offline execution. Depending on ‘n’, the processor 302 may calculate a certain number of tasks ‘N’ and tags these as active tasks. In an embodiment, the active tasks may refer to the tasks that require mandatory execution, failing which the reputation of the crowdworker associated with the client device 106 may be reduced and the crowdworker may be blocked from working on the crowdsourcing platform server 102 for certain period. Further, the number ‘N’ may be calculated, ensuring that the number of active tasks from each category is more than the minimal amount defined by a requester for each respective category. The rest ‘n-N’ tasks may be tagged as passive tasks.

Considering an example, the client device 106 opts for ‘10’ tasks from ‘Digitization’ and ‘15’ tasks from ‘Image Labelling’. Moreover, the requester always asks for 70% of the tasks selected to be necessarily executed.

$$Digitization tasks = 10$$

$$Image Labelling tasks = 15$$

$$Minimum Digitization tasks defined by requesto r = 70 \% of Digitization tasks = 7$$

$$Minimum Image Labelling tasks defined by requestor = 70 \% of Image Labelling tasks = 10.5$$

$$Total number of taks ( n ) = ( Digitization tasks + Image Labelling tasks ) = ( 10 + 15 ) = 25$$

In an embodiment, the processor 302 may determine the number of active digitization tasks such that the number of active digitization tasks are more than the minimum digitization tasks defined by the requestor. In an embodiment, one or more extra digitization tasks may be tagged as active digitization tasks. For example, the number of active digitization tasks may be 8, while the number of minimum active digitization tasks is 7. In a similar way, the processor 302 may determine the number of active image labelling tasks such that the number of active image labelling tasks are more than the minimum image labelling tasks defined by the requestor. Thus, one or more extra image labelling tasks may be tagged as active image labelling tasks. For example, the number of active image labelling tasks may be 12, while the number of minimum active image labelling tasks is 10.5. Thus:

$$\begin{matrix}Total number of active tasks ( N ) = ( \begin{matrix}Active Digitization tasks + \\ Active Image Labelling tasks\end{matrix} ) \\ = ( 8 + 12 ) = 20\end{matrix}$$

$$Total number of Passive tasks = ( n - N ) = ( 25 - 20 ) = 5$$

It will be apparent to a person skilled in the art that the processor 302 may determine the number of active tasks for a category based on a preconfigured value such that the determined number of active tasks is more than the minimum tasks defined by the requestor for that category.

In an embodiment, the selected active tasks by the client device 106 may not be available for execution by other client devices; however, the passive tasks may be available for selection and execution to other client devices.

In an embodiment, the processor 302 maintains a client device information list in the memory 304 including the information pertaining to one or more client devices communicatively coupled to the host device 104. The client device information list, as depicted in Table 1, may include tasks corresponding to the one or more client devices, such as primary, secondary, recently executed tasks with the highest rewards, recurrent, autosuggested tasks by the processor 302.

TABLE 1
Client Device Information List

| CLIENT | | | |
|---|---|---|---|
| DEVICE | PRIMARY | SECONDARY | RECENT |
| Client Device | Language | hyperlink | Targeted Photography |
| 106a | Translation | Testing | |
| Client Device | Data Entry | Language | Survey Completion |
| 106b | | Translation | |
| Client Device | Product | Survey | Language Translation |
| 106c | Review | Completion | |
| | Writing | | |
| Client Device | Essay Writing | Targeted | Text/image-Analysis |
| 106n | | Photography | |

As depicted in Table 1, the processor 302 may maintain the information pertaining to preferences (e.g., primary/secondary tasks) selected by the different client devices, and may utilize such information to facilitate different client devices for the selection of the one or more first crowdsourcing tasks.

At step 416, the one or more first crowdsourcing tasks selected by the client device 106 (as discussed in conjunction with the previous step) are received from the crowdsourcing platform server 102. In an embodiment, the processor 302 may transmit the first request to the crowdsourcing platform server 102 to retrieve the selected one or more first crowdsourcing tasks. The first request may be on a Hypertext Transfer protocol (HTTP) interface. In an embodiment, the crowdsourcing platform server 102, based on the first request, may transmit the one or more first crowdsourcing tasks to the processor 302.

At step 418, the one or more first crowdsourcing tasks are transmitted to the client device 106. The processor 302 may transmit the one or more first crowdsourcing tasks to the client device 106, received from the crowdsourcing platform server 102. Further, the one or more first crowdsourcing tasks may be transmitted over the protocols discussed above (e.g., Bluetooth, infrared, USB tethering, Wi-Fi tethering, and NFC).

As discussed, if at the step 412 it is determined that the handshake request does not correspond to accessing of the one or more first crowdsourcing tasks; the processor 302 performs the step 420.

At the step 420, the processor 302 determines whether the handshake request corresponds to submission of the one or more first responses associated with the one or more first crowdsourcing tasks. If it is determined that the handshake request corresponds to submission of the one or more first responses associated with the one or more first crowdsourcing tasks, step 422 is performed else, method ends.

At the step 422, the processor 302 receives the one or more first responses associated with the one or more first crowdsourcing tasks. The processor 302 may receive the one or more first responses over the communication protocols, such as Bluetooth, NFC, infrared, USB tethering, Wi-Fi tethering, and the like.

In an embodiment, the processor 302 may determine a machine-learning model, based on the one or more first responses associated with the one or more first crowdsourcing tasks. The machine-learning model may be utilized for validating the one or more second responses associated with one or more future crowdsourcing tasks, received from the client device 106. In an embodiment, a machine learning algorithm, for example character prediction for digitization, may be determined by the processor 302.

At step 424, the processor 302 transmits the one or more first responses associated with the one or more first crowdsourcing tasks to the crowdsourcing platform server 102. In an embodiment, the crowdsourcing platform server 102 may further transmit the one or more first responses to the requestors associated with the respective one or more first crowdsourcing tasks.

At step 426, based on the accuracy of the submitted one or more first responses associated with the one or more first crowdsourcing tasks, the host device 104 receives the rewards from the crowdsourcing platform server 102.

At step 428, the processor 302 facilitates sharing of the rewards with the client device 106. The sharing of the rewards is based on the message transmitted to the client device 106 at the step 404. In an embodiment, the processor 302 may notify the client device 106 about the percentage of the reward share to be provided by the crowdsourcing platform server 102. As discussed, the processor 302 may notify the client device 106, through a pop-up/flash message on a display associated with the client device 106, about the value of the rewards to be shared with the client device 106.

However, the scope of the disclosure should not be limited to the computing device 300 as the host device 104. The computing device 300 can also be realized as the client device 106.

It will be apparent to a person skilled in the art that in this way if the client device 106 has limited internet connectivity (e.g., due to weak network availability through the service provider of the client device 106), the client device 106 may utilize the internet connection available on the host device 104. Thus, if the host device 104 has good internet connectivity (e.g., due to strong network availability through the service provider of the host device 104), the host device 104 may facilitate the client device 104 to access the crowdsourcing platform server 102 to access the crowdsourcing tasks or to submit the associated responses.

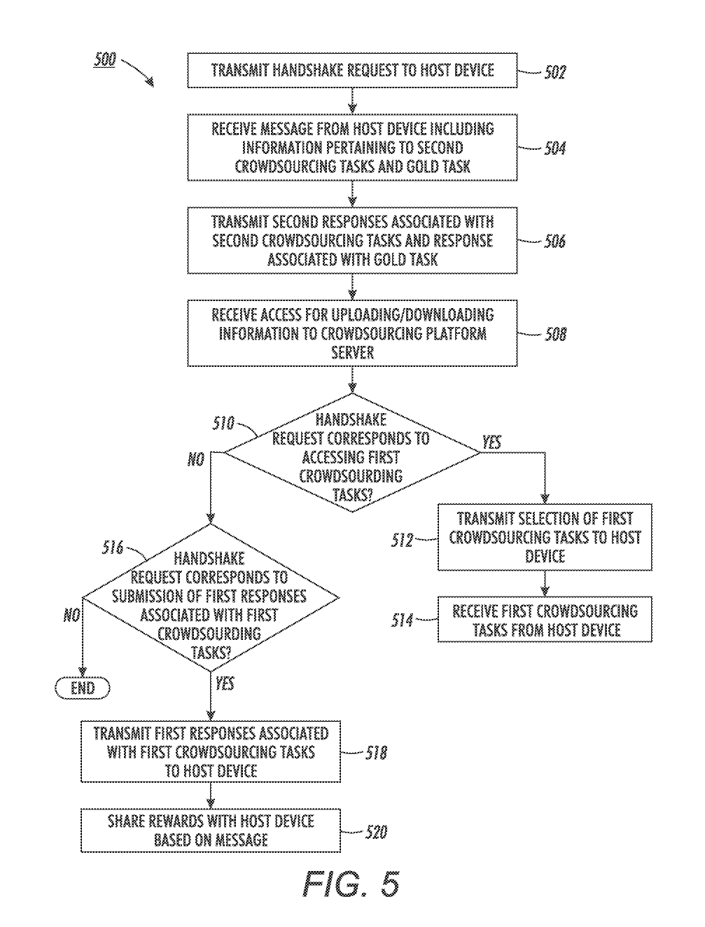

FIG. 5 is a flowchart 500 that illustrates a method for accessing crowdsourcing tasks, in accordance with at least one embodiment. The flowchart 500 is described in conjunction with FIG. 1 and FIG. 2. For the purpose of ongoing description, the computing device 300 shown in FIG. 2 is considered as the client device 106.

At step 502, the processor 302 transmits the handshake request to the host device 104 for communicating with the crowdsourcing platform server 102. The processor 302 transmits the handshake request through at least one of a Bluetooth protocol, a near field communication (NFC) protocol, an infra-red protocol, a Universal Serial Bus (USB) tethering, or a Wi-Fi tethering. In an embodiment, the processor 302 may transmit the handshake request to more than one host device. In an embodiment, the crowdworker who is operating on the client device 106 may want to access the one or more first crowdsourcing tasks that are available on the crowdsourcing platform server 102. In such a scenario, the processor 302 may search for the host device 104 through one or more protocols and transmit the handshake request for accessing the one or more first crowdsourcing tasks. In an embodiment, the processor 302 may transmit the handshake request for submitting the one or more first responses associated with the one or more first crowdsourcing tasks. In such a scenario, the processor 302 may have previously attempted the one or more first crowdsourcing tasks through other host devices, and may subsequently transmit the handshake request for submitting the one or more first responses.

At step 504, the processor 302, in response to the handshake request, receives the message from the host device 104. The message includes the information pertaining to the one or more second crowdsourcing tasks. The one or more second crowdsourcing tasks may refer to the crowdsourcing tasks from the predetermined category that the processor 302 may be required to execute to initiate the communication with the crowdsourcing platform server 102 (through the host device 104). Thus, in an embodiment, the host device 104 utilizes the one or more second crowdsourcing tasks for authentication/authorization of the client device 106. In an embodiment, the predetermined category is determined such that it includes the crowdsourcing tasks that may be completed by least skillful crowdworkers associated with the crowdsourcing platform server 102. In an embodiment, the crowdsourcing platform server 102 may maintain the list of skills required to perform the one or more second crowdsourcing tasks, and subsequently may transmit the one or more second crowdsourcing tasks to the host device 104, which further transmits the one or more second crowdsourcing tasks to the processor 302.

In an embodiment, along with the one or more second crowdsourcing tasks, the processor 302 may receive the gold task from the host device 104. In an embodiment, the response associated the gold task, provided by the processor 302, may be used by the host device 104 to validate the one or more second responses associated with the one or more second crowdsourcing tasks, provided by the processor 302. For example, the host device 104 may know the correct response associated with the gold task, and if the response, provided by the processor 302, is found to be correct, the host device 104 considers other responses, associated with the one or more second crowdsourcing tasks, as correct. Thus, in this way, the host device 104 may perform the function (i.e., the validation) that is typically performed by the requesters.

In an embodiment, the host device 104 may maintain a pool of gold tasks. Further, the host device 104 may track the processor 302 and a set of gold tasks, from the pool of gold tasks, which have been transmitted to the processor 302, such that the processor 302 is not transmitted the same task, as gold task, for two times. At every instance, on receiving the handshake request by the processor 302, the host device 104 determines a gold task (from the pool of gold tasks) to be transmitted to the processor 302.

In an embodiment, the processor 302 may receive the one or more second crowdsourcing tasks and the gold task out of the pool of gold tasks from the host device 104. In such a scenario, the host device 104 may have received the one or more second crowdsourcing tasks and the pool of gold tasks from the crowdsourcing platform server 102. Further, the processor 302 may utilize the internet connection available on the host device 104 to initiate a communication session (e.g., over Hypertext Transfer Protocol (HTTP)) with the client device 106.

In an embodiment, the processor 302, in the message, may receive the information pertaining to a sharing of the rewards, associated with the one or more first crowdsourcing tasks, between the host device 104 and the client device 106. For example the message, received by the processor 302, in response to the handshake request, may include the percentage of the rewards associated with the crowdsourcing tasks (received from the crowdsourcing platform server 102) that the host device 104 will keep for itself. In an embodiment, prior to receiving the one or more second crowdsourcing tasks and the gold task, the processor 302 may receive such information (i.e. pertaining to the sharing of the rewards), and based on the acceptance by the client device 106, the processor 302 may subsequently receive the one or more second crowdsourcing tasks and the gold task, as discussed above.

At step 506, the one or more second responses associated with the one or more second crowdsourcing tasks and the gold task are transmitted by the processor 302. In an embodiment, the processor 302 may transmit the one or more second responses associated with the one or more second crowdsourcing tasks and the response associated with the gold task, to the host device 104. As discussed, the processor 302 may transmit these responses over the communication protocols, such as Bluetooth, NFC, infrared, USB tethering, Wi-Fi tethering, and the like. In this way, in a scenario when the client device 106 does not have the internet connectivity available with it, the processor 302 may still execute a task and provide a response to the host device 104.

At step 508, the processor 302 receives access for uploading/downloading information to the crowdsourcing platform server 102. In an embodiment, the processor 302 may be allowed access to the crowdsourcing platform server 102, based on the one or more second responses associated with the one or more second crowdsourcing tasks and the response associated with the gold task, transmitted to the host device 104. That is, if the host device 104 determines that the one or more second responses are correct, the host device 104 may allow the processor 302 to access the crowdsourcing platform server 102 through it. In an embodiment, downloading of the information may correspond to accessing the one or more first crowdsourcing tasks, and the uploading of the information may correspond to submitting one or more first responses associated with the previously attempted one or more first crowdsourcing tasks. In an embodiment, the host device 104 may define a percentage of correct responses, from the one or more received second responses, for determining access of the one or more first crowdsourcing tasks, to the processor 302. For example, the host device 104 may define that if the percentage of the correct one or more second responses received from the processor 302 is at least 75%, the processor 302 may be allowed access of the one or more first crowdsourcing tasks available on the crowdsourcing platform server 102.

In an embodiment, the processor 302 may be notified about the provision of the access of the crowdsourcing platform server 102. For example, the host device 104 may notify the processor 302, through a pop-up/flash message on a display associated with the client device 106, about the provision of access.

At step 510, it is determined whether the handshake request corresponds to the access of the one or more first crowdsourcing tasks. If the processor 302 determines that the handshake request corresponds to the access of the one or more first crowdsourcing tasks, step 512 is performed else step 516 is performed.

At the step 512, the processor 302 transmits a selection of the one or more first crowdsourcing tasks to the host device 104. In an embodiment, the host device 104 may offer multiple options to minimize the time spent by the processor 302 on task selection. The description related to multiple alternatives for task selection, active tasks, passive tasks may be considered similar to the explanation as discussed in conjunction with the step 314 of FIG. 3, therefore, any person skilled in the art may refer to the step 314 of FIG. 3.

At step 514, the one or more first crowdsourcing tasks selected by the processor 302 (as discussed in conjunction with the previous step) are received from the host device 104. In an embodiment, the host device 104 may transmit the first request to the crowdsourcing platform server 102 to retrieve the selected one or more first crowdsourcing tasks. The first request may be on a Hypertext Transfer protocol (HTTP) interface. In an embodiment, the crowdsourcing platform server 102, based on the first request, may transmit the one or more first crowdsourcing tasks to the host device 104, and further transmit the one or more first crowdsourcing tasks to the processor 302.

As discussed, if at the step 510 it is determined that, the handshake request does not correspond to accessing of the one or more first crowdsourcing tasks; the processor 302 performs the step 516.

At the step 516, the processor 302 determines whether the handshake request corresponds to submission of the one or more first responses associated with the one or more first crowdsourcing tasks. If it is determined that the handshake request corresponds to submission of the one or more first responses associated with the one or more first crowdsourcing tasks, step 518 is performed.

At the step 518, the processor 302 transmits the one or more first responses associated with the one or more first crowdsourcing tasks to the host device 104. The processor 302 may transmit the one or more first responses over the communication protocols, such as Bluetooth, NFC, infrared, USB tethering, Wi-Fi tethering, and the like. In this way, in a scenario when the client device 106 does not have the internet connectivity available with it, the processor 302 may still execute a task and provide a response to the host device 104. In an embodiment, the requestors who had posted the one or more first tasks on the crowdsourcing platform server 102 may pick the one or more first responses associated with the one or more first crowdsourcing tasks, executed by the processor 302 and submitted by the host device 104 to the crowdsourcing platform server 102.

At step 520, the processor 302 facilitates sharing of the rewards with the host device 104. The sharing of the rewards is based on the message received by the processor 302 by the host device 104 at the step 404. In an embodiment, the processor 302 may be notified by the host device 104 about the percentage of the reward share to be provided by the crowdsourcing platform server 102. For example, the processor 302 may be notified by the host device 104, through a pop-up/flash message on a display associated with the client device 106, about the value of the rewards to be shared with the client device 106.

A person skilled in the art would appreciate that the scope of the disclosure is not limited a predetermined reward share. The disclosure may be implemented with different percentages of reward share based on various criteria without departing from the scope of the disclosure.

In an embodiment, the processor 302 may have submitted the one or more second crowdsourcing tasks transmitted by the host device 104. The processor 302 may be downloading or uploading data from the crowdsourcing platform server 102. In case the host device 104 is suddenly unavailable and the processor 302 is downloading tasks such that the number of tasks downloaded for a category is more than a predefined threshold, then the processor 302 still executes those tasks. Based on the accuracy of these submitted tasks, revenue is generated and provided to the client device 106. In such scenario, sudden absence of the host device 104 may not have any affect. In an embodiment, if the number of tasks is less than the predefined threshold when the host device 104 is suddenly unavailable, then these tasks are not transmitted to the processor 302 and hence there is no loss of reputation score corresponding to the crowdworker. In an embodiment, if the processor 302 is uploading executed tasks and the host device 104 is suddenly unavailable, the crowdworker associated with the processor 302 is paid for all the submitted tasks. The remaining tasks may be submitted by the processor 302 via other host device or internet connection.

Referring to FIG. 1, in an example, all the client devices may act as consumers, but not all the consumers are clients. Alternatively, all the host devices may act as consumers, but not all consumers are hosts. In an embodiment, the client device 106 may act as a host device by activating hotspot functionality. Therefore, the client device 106 may offer internet connectivity to other client device in the system environment 100.

It will be apparent to a person skilled in the art that different steps, as disclosed above, may be performed in different order than illustrated in the flowchart 400. For example, the determination by the processor 302 whether the handshake request corresponds to access of the first crowdsourcing tasks or corresponds to submission of first responses may be performed as the first step, without departing from the scope of the disclosure.

The disclosed embodiments encompass numerous advantages. Typically, for executing the crowdsourcing tasks, the crowdworkers need to be connected to the crowdsourcing platform server through the internet. Thus, a part of the earnings of the crowdworkers by performing the crowdsourcing tasks is lost by paying the charges for the continuous internet connectivity for the entire period of task selection, task execution, and task submission. In addition, if the continuous internet connectivity is not good, the crowdworkers may have to face reduction of the productivity (e.g., due to network latency caused by weak internet connectivity). Through various embodiments of the methods and systems for accessing/distributing the crowdsourcing tasks, it is disclosed that the crowdworkers (who are using the client devices) may download the tasks using the internet connection provided by the host device. Similarly, the crowdworkers may submit the responses for the crowdsourcing tasks through the internet connection provided by the host device. In this way, even if the client device does not have continuous and good internet connectivity, the crowdworkers may be execute the task through the host device. In addition, as disclosed, the client device may pay the host devices by performing the second crowdsourcing tasks, and, thus, increasing the earnings of the crowdworkers. Thus, this type of scenario may motivate the crowdworkers to participate more in performing the tasks through crowdsourcing.

In addition, it is disclosed that the host device may mediate between the client device and the crowdsourcing platform server. Thus, the crowdworkers possessing the host device may act as pseudo-platform, since they are distributing the tasks to the client device similar to a crowdsourcing platform server. Further, through validating the responses of the crowdsourcing tasks (e.g., second crowdsourcing task using the gold task, or through a machine learning model), the host device may act as requester that typically performs the validation. Thus, these scenarios may enhance the role of the crowdworker in participating in the crowdsourcing activities, and may boost the crowdsourcing ecosystem as a whole.

In addition, by creating the machine learning model using the vast and varied sample data from crowdsourcing may further enhance the productivity of the crowdworkers (e.g., through auto-completion of the tasks using the machine learned models).

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for formulating a policy for crowdsourcing of tasks have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for distributing crowdsourcing tasks to a client device with sporadic internet connectivity, the method comprising:
receiving, by a host device, a handshake request from said client device at least for accessing one or more first crowdsourcing tasks;
transmitting, by said host device, a message to said client device in response to said handshake request, wherein said message comprises at least an information pertaining to one or more second crowdsourcing tasks, received from a crowdsourcing platform server; and
transmitting, by said host device, said one or more first crowdsourcing tasks to said client device based at least on a validation of one or more second responses, received from said client device, associated with said one or more second crowdsourcing tasks.

2. The method of claim 1 further comprising receiving, by said host device from said crowdsourcing platform server, rewards associated with said one or more second crowdsourcing tasks.

3. The method of claim 2 further comprising determining, by said host device, a count of said one or more second crowdsourcing tasks based at least on said handshake request and said rewards associated with said one or more second crowdsourcing tasks.

4. The method of claim 1, wherein said message comprises an information pertaining to a sharing of rewards, associated with said one or more first crowdsourcing tasks, between said host device and said client device.

5. The method of claim 1, wherein said handshake request corresponds to submission of one or more first responses associated with said one or more first crowdsourcing tasks.

6. The method of claim 5 further comprising transmitting, by said host device, said one or more first responses to said crowdsourcing platform server.

7. The method of claim 5 further comprising determining, by said host device, a machine learning model based on said one or more first responses, wherein said machine learning model is utilized for validating one or more responses, received from said client device, associated with one or more future crowdsourcing tasks.

8. The method of claim 1 further comprising transmitting, by said host device, a gold task along with said one or more second crowdsourcing tasks to said client device, wherein a response, associated with said gold task, received from said client device is used for said validation of said one or more second responses.

9. The method of claim 1, wherein each of said one or more second crowdsourcing tasks corresponds to a predetermined category, wherein skill set requirements associated with each crowdsourcing task in said predetermined category is fulfilled by skill set associated with each crowdworker associated with said crowdsourcing platform server.

10. The method of claim 1 further comprising determining, by said host device, an active time available for said client device to complete said one or more second crowdsourcing tasks, wherein said active time is less than an expiry period associated with said one or more second crowdsourcing tasks.

11. The method of claim 1, wherein said handshake request is received through at least one of a Bluetooth protocol, a near field communication (NFC) protocol, an infra-red protocol, a Universal Serial Bus (USB) tethering, or a Wi-Fi tethering.

12. The method of claim 1, wherein said host device maintains a client device information table comprising information pertaining to one or more said client devices communicatively coupled to said host device.

13. The method of claim 1 further comprising authenticating, by said host device, said client device for a resource availability on said client device to execute said one or more second crowdsourcing tasks and security threats from said client device.

14. The method of claim 1 further comprising monitoring, by said host device, time spent by said client device to execute said one or more second crowdsourcing tasks.

15. A method for accessing crowdsourcing tasks on a client device with sporadic internet connectivity, the method comprising:
transmitting, by said client device, a handshake request to a host device at least for accessing one or more first crowdsourcing tasks available on a crowdsourcing platform server;
receiving, by said client device, a message from said host device in response to said handshake request, wherein said message comprises at least an information pertaining to one or more second crowdsourcing tasks and an information pertaining to a gold task;
transmitting, by said client device, one or more second responses, associated with said one or more second crowdsourcing tasks, and a response, associated with said gold task, to said host device, wherein said response, associated with said gold task, is utilized for validating said one or more second responses; and
receiving, by said client device, said one or more first crowdsourcing tasks from said host device based at least on said validation of said one or more second responses.

16. The method of claim 15, wherein said host device receives rewards associated with said one or more second crowdsourcing tasks.

17. The method of claim 16, wherein a count of said one or more second crowdsourcing tasks is determinable from said rewards associated with said one or more second crowdsourcing tasks.

18. The method of claim 15, wherein said message comprises an information pertaining to a sharing of rewards, associated with said one or more first crowdsourcing tasks, between said host device and said client device.

19. The method of claim 15, wherein said handshake request corresponds to submission of one or more first responses associated with said one or more first crowdsourcing tasks.

20. The method of claim 19 further comprising transmitting, by said client device, said one or more first responses to said host device, wherein said one or more first responses are further transmitted, by said host device, to said crowdsourcing platform server.

21. The method of claim 15, wherein each of said one or more second crowdsourcing tasks corresponds to a predetermined category, wherein skill set requirements associated with each crowdsourcing task in said predetermined category is fulfilled by skill set associated with each crowdworker associated with said crowdsourcing platform server.

22. The method of claim 15, wherein said handshake request is received through at least one of a Bluetooth protocol, a near field communication (NFC) protocol, an infra-red protocol, a Universal Serial Bus (USB) tethering, or a Wi-Fi tethering.

23. A method for distributing crowdsourcing tasks, the method comprising:
receiving, by a crowdsourcing platform server, a first request, from a host device, for accessing one or more first crowdsourcing tasks, wherein said first request corresponds to a handshake request received, by said host device, from a client device for accessing said one or more first crowdsourcing tasks;
receiving, by said crowdsourcing platform server, a second request, from said host device, for accessing one or more second crowdsourcing tasks, wherein one or more second responses, associated with said one or more second crowdsourcing tasks and provided by said client device, are indicative of said access of said one or more first crowdsourcing tasks, by said client device; and
transmitting, by said crowdsourcing platform server, said one or more first crowdsourcing tasks to said host device, based at least on a validation, by said host device, of said one or more second responses.

24. The method of claim 23, wherein said host device transmits a message in response to said handshake request, wherein said message comprises at least an information pertaining to said one or more second crowdsourcing tasks.

25. The method of claim 24 further comprising rewarding, by said crowdsourcing platform server, said host device with rewards associated with said one or more second crowdsourcing tasks.

26. The method of claim 25, wherein a count of said one or more second crowdsourcing tasks is determinable from said rewards associated with said one or more second crowdsourcing tasks.

27. The method of claim 23, wherein said handshake request corresponds to submission, by said client device, of one or more first responses associated with said one or more first crowdsourcing tasks.

28. The method of claim 27 further comprising receiving, by said crowdsourcing platform server, said one or more first responses.

29. The method of claim 23 further comprising transmitting, by said crowdsourcing platform server, a gold task along with said one or more second crowdsourcing tasks, wherein a response, associated with said gold task, provided by said client device, is used for said validation.

30. The method of claim 23, wherein each of said one or more second crowdsourcing tasks corresponds to a predetermined category, wherein skill set requirements associated with each crowdsourcing task in said predetermined category is fulfilled by skill set associated with each crowdworker associated with said crowdsourcing platform server.

31. The method of claim 23, wherein each of said first request and said second request is received on a Hypertext Transfer protocol (HTTP) interface.
